(19) United States
(12) Patent Application Publication
(10) Pub. No.: US 2014/0046696 A1
(43) Pub. Date: Feb. 13, 2014

(54) Systems and Methods for Pharmacogenomic Decision Support in Psychiatry

(71) Applicant: AssureRx Health, Inc., Mason, OH (US)

(72) Inventors: Gerald A. Higgins, Takoma Park, MD (US); C. Anthony Altar, Mason, OH (US)

(21) Appl. No.: 13/963,901

(22) Filed: Aug. 9, 2013

Related U.S. Application Data
(60) Provisional application No. 61/681,813, filed on Aug. 10, 2012.

(51) Int. Cl. G06F 19/00

(52) U.S. Cl. CPC G06F 19/3456; G06F 19/345
USPC 705/3

(57) ABSTRACT

The present invention provides methods and systems or apparatuses, to analyze multiple molecular and clinical variables from an individual diagnosed with a psychiatric disorder, such as post-traumatic stress disorder (PTSD), in order to optimize medication selection for therapeutic response. Molecular co-variables include polymorphisms in genes including those involved in central control and mediation of the hypothalamic-pituitary axis (HPA) stress response, the density of methylation in regulatory regions of said polymorphic genes, polymorphisms in genes that encode cytochrome P450 enzymes responsible for drug metabolism, and drug-drug and drug-gene interactions. Clinical co-variables include but are not limited to the sex, age and ethnicity of that individual, medication history, family history, diagnostic codes, Pittsburgh insomnia rating score, and Charlson index score. The system makes a determination based on unstructured and structured data types derived from internal and external knowledge resources to determine psychotropic drug choice that best matches the molecular and clinical variation profile of an individual patient. The decision support system provides a therapeutic recommendation for a clinician based on the patient's variation profile.

### TECHNICAL FIELD OF THE INVENTION

The invention relates to clinical decision support particularly as it relates to the selection of medications in psychiatry.

### BACKGROUND OF THE INVENTION

Medications used to treat psychiatric diseases are clinically suboptimal. Psychiatry is the only medical specialty that relies on poorly-defined diagnostic criteria, and is based not on objective biomarkers but depends almost entirely on surrogate markers generated by the patient's self-report. Due to the wide inter-population and inter-individual variability in the efficacy and toxicity of psychotropic drugs, such as selective serotonin reuptake inhibitors (SSRIs), clinicians perform “trial and error” medication prescribing to an already suffering patient population. Psychiatric disease in the U.S. accounts for the largest healthcare burden of any disease when measured by the international standard of quality-adjusted life year (QALY). QALY, developed by the World Health Organization, is a measure of disease burden, including both the quality and the quantity of life lived.

In the genomic era, pharmacogenomics-based approaches seek to tailor psychiatric therapy to the genomic profile of an individual patient. However, over a decade of genome-wide association scans (GWAS) of possible associations between psychopathology risk and genomic sequences has yielded almost no compelling results, even though many psychiatric disorders have a strong component of heritability. Similarly, the literature on pharmacogenomics in psychiatry has yielded confusing results, with some exceptions showing the association of single nucleotide polymorphisms (SNPs) in pharmacokinetic genes of the cytochrome P450 gene families in relationship to individual variations in drug levels or response (Altar et al., 2013).

A challenge for pharmacogenomic decision support has traditionally been the lack of algorithmic solutions for processing of both unstructured and structured data to arrive at a decision. This is especially pronounced in psychiatry, where much of the data about any given patient may be contained in notes from a clinician that is free text. Recently, a number of machine-learning based approaches have been utilized to process unstructured data such as that found in clinical records. Machine learning is data-driven. As a result, the search for patterns is usually automatic and may not involve substantial interaction with the expert.

Semantic web technologies are based on two ideas: resolvable identifiers and machine-understandable descriptions. Internationalized Resource Identifiers (IRI) can be used to identify any entity, whether it is a psychiatric diagnostic code, molecular data, psychotropic drug, genetic variation, a drug-drug interaction or a clinical report in free text. The Resource Description Framework (RDF) is a machine-understandable format that provides a simple model in which statements are captured using subject-predicate-object triples, where the predicate indicates a relation between the subject and the object. Web Ontology Language (OWL) is more sophisticated than RDF and is based on formal logic that can be used to capture general rules from the information it has access to. This allows OWL to answer questions that enable automated reasoning. OWL has already been used on many occasions to formally represent pharmacogenomics knowledge. Through the establishment of explicit formal specification of the concepts in a particular domain and relations among them, ontologies provide the basis for the reuse and integration of valuable domain knowledge within applications.

In addition to unstructured data, structured data are available from a variety of sources, including the electronic health record, computerized physician order entry systems, lab results from genomic analyses, diagnostic codes, and scales used in psychiatry that are intended to put a quantitative label on what may be considered as subjective results, including the extent of co-morbidity of a particular patient by the Charlson Index, the Pittsburgh Insomnia rating score, clinical severity as measured by the Hamilton Depression rating scale, Columbia Suicide Severity Rating Scale, the Cincinnati Suicide Scale, and the Clinician-Administered PTSD Scale (CAPS). Structured data may also need to be processed using different algorithmic strategies, including linear regression for determination of drug dose, multivariate regression, cluster analysis, rules-based or neural network-based pattern recognition, and multi-dimensional data reduction methods.

There is a need to more efficiently and effectively tailor psychiatric therapy to individual patients. The present invention addresses this need with methods and systems or apparatuses, to analyze multiple molecular and clinical variables from an individual diagnosed with a psychiatric disorder, such as post-traumatic stress disorder (PTSD), in order to optimize medication selection for therapeutic response.

### SUMMARY OF THE INVENTION

The present invention provides systems and methods for processing and integrating structured and unstructured data types into data-rich three dimensional tri-graphs that may be used for clinical decision support.

In one aspect, the invention provides a method for selecting a medication for administration to a psychiatric patient in need of treatment for anxious depression or post-traumatic stress disorder (PTSD) by creating a patient-specific phenotype model and classifying the patient into one of a set of pre-defined phenotype models, the phenotype model indicating the diagnostic phenotype of the patient and the medication for administration to the patient, the method comprising the steps of

receiving at a semantic ontology processor a set of patient specific input data in the form of unstructured data including clinical narratives, written prescriptions, and/or notes written in free text;

processing the unstructured data through a series of steps including filtering the data to detect and correct errors, sorting the data through higher order labeling and indexing to partition the data that can be used for pattern recognition, tokenization, by which is meant the process of breaking a stream of text up into words, phrases, symbols, or other meaningful elements called tokens (the list of tokens becomes input for further processing), and lexicon verification against a standard collection of medical terms, for example SNOMED CT and ULMS, as defined herein below;

converting the data into three dimensional vector space in the form of a three dimensional graph (tri-graph);

extracting from the processed patient data a set of clinical variables associated with anxious depression or PTSD;

applying a pre-trained machine learning algorithm to the set of clinical variables wherein the machine learning algorithm is operative to identify the set of variables and associations that are meaningful for classification;

outputting from the machine learning algorithm the most probable classification of the patient-specific unstructured data as a first pattern classification set in the form of a three dimensional graph (tri-graph);

receiving at a second processor a set of patient specific input data in the form of structured data including genetic data;

processing the structured data through a series of steps including extracting, sorting and binning the data;

applying a pattern recognition algorithm to the processed data;

outputting the most probable classification of the patient-specific structured data as a second pattern classification set in the form of a three dimensional graph (tri-graph);

receiving at a data fusion module the first and second pattern classification sets and integrating the first and second data sets using a multi-modal approach;

outputting the result as a patient-specific phenotype model;

comparing the patient-specific phenotype model to a set of pre-defined phenotype models stored in the system knowledge discovery dataset (KDD) using three dimensional isograph pattern matching;

outputting the most probable classification of the patient-specific phenotype model; and

selecting a medication based on the output phenotype model.

In one embodiment, the method further comprises the step of administering the medication to the patient.

In one embodiment, the method further comprises compensating for missing patient data using probable inference from the set of pre-defined phenotype models stored in the system KDD.

In one embodiment, the set of pre-defined phenotype models stored in the system KDD is selected from the set of PTSD phenotype models in Table 1.

In one embodiment, the structured data further includes epigenetic data and/or clinical data.

In one embodiment, the genetic data includes the patient's polymorphic status at a gene for a single nucleotide polymorphism (SNP) or a multi-nucleotide polymorphism (MNP) and the gene is selected from the group consisting of ADCYAP1R1, ADRA2A, BDNF, CRHBP, CRHR1, FKBP5, HT2RA, NR3C1, NTRK2 and SLC6A4.

In one embodiment, the SNP or MNP is selected from the group consisting of ADCYAP1R1 rs2267735, ADRA2A rs6311, ADRA2A rs11195419, BDNF rs962369, CRHBP rs10473984, CRHR1 rs4792887, CRHR1 rs110402, FKBP5 rs3800373, FKBP5 rs1360780, FKBP5 rs9296158, HT2RA rs9316233, NR3C1 rs852977, NR3C1 rs6195, NR3C1 rs10052957, NR3C1 rs41423247, NTRK2 rs1439050, and SLC6A4XL28 variant selected from the XLA, LA, S, and LG variants.

In one embodiment, the genetic data further includes the patient's polymorphic status in at least three cytochrome P450 genes selected from CYP2D6, CYP2C19, and CYP1A2. In another embodiment, the genetic data further includes the patient's polymorphic status in at least three cytochrome P450 genes selected from CYP2D6, CYP2C19, and CYP1A2 and the serotonin transporter gene, SLC6A4 and the serotonin 2A receptor gene, HTR2A.

In one embodiment, the epigenetic data includes the methylation density of a genetic regulatory element selected from the group consisting of the first CpG island of ADCYAP1R1, Exon 1_{F} of NR3C1 promoter, intron 2 or intron 7 of FKBP5, cg22584138 of SLC6A4, and cg05951817 of SLC6A4.

In one embodiment, the clinical data includes at least three or more clinical co-variables selected from the group consisting of Age, Height, weight (Body Surface Area, BSA), Ethnicity, Gender, Number of medications, Drug-Drug Interactions, Drug-Gene Interactions, Number of co-morbid psychiatric diseases, Number of co-morbid non-psychiatric diseases, Structured family history, and one or more psychiatric scales selected from the group consisting of the Pittsburgh Insomnia Rating Scale (PIRS) Sleep Parameters Score, the Columbia Suicide Severity Rating Scale, the Cincinnati Suicide Scale, the Hamilton Rating Scale for Depression, the 16-item Quick Inventory of Depression Symptomology (QIDS-C16) scale, the 9-item Patient Health Questionnaire (PHQ-9), the Clinical Global Impression of Severity, the Clinical Global Impression of Improvement, and the Clinical Global Impression of Efficacy.

In a second aspect, the present invention provides a system for pharmacogenomic decision support in psychiatry, the system comprising a text mining module, a data mining module, a decision module, and a knowledge discovery dataset (KDD),

the text mining module being operative to receive input unstructured text data, the module comprising
a semantic ontology processor connected to a semantic web interface and operative to extract data from a plurality of web-based medical ontologies and to transform the data into three dimensional vector space in the form of a three dimensional graph (trigraph),
a learning machine operative to apply an unsupervised machine learning process to an ontology training set created by the semantic ontology processor from the input unstructured text data and the data extracted through the semantic web interface into a pattern classification set;

the data mining module being operative to receive structured input data including structured clinical data, genomic data, and/or epigenomic data, the module comprising
a data filter operative to extract data, correct errors in the data, sort the data, and transform the data into three dimensional vector space in the form of a three dimensional graph (trigraph),
a pattern recognition module, and
a data fusion module comprising a learning machine operative to apply an unsupervised machine learning process to integrate the data from the pattern recognition module into a pattern classification set,

the decision module operative to receive the pattern classification sets from the text mining module and the data mining module and to compare the sets to a set of pre-defined phenotype models and identify the most probable match to a pre-defined phenotype model using pattern matching in three dimensional vector space, and

the knowledge discovery dataset (KDD) having stored within it the pre-defined phenotype models.

In another aspect, the invention provides a method for creating a patient-specific phenotype model (also referred to as a set phenotype) for a psychiatric disorder, preferably anxious depression or post-traumatic stress disorder, wherein the patient-specific phenotype model is in the form of a three dimensional tri-graph in vector space. In one embodiment, the method comprises at least two learning machines. Preferably, the learning machines are support vector machines. In accordance with this embodiment, one learning machine is pre-trained using a set of error-free clinical data in text format (unstructured data) as the training set. The second learning machine is pre-trained using a set of structured data comprising or consisting of data having known associations or correlations with the psychiatric disorder as the training set. In one embodiment, the structured data comprises or consists of genomic data. In one embodiment, the structured data further comprises epigenomic data and structured clinical data.

In one embodiment, the method further comprises receiving patient-specific structured input data comprising genomic data at a first processor, processing the structured data through a series of steps including extracting, sorting and binning the data; extracting from the processed data a set of variables associated with the psychiatric disorder; applying a pre-trained machine learning algorithm to the set of variables wherein the machine learning algorithm is operative to identify the set of variables and associations that are meaningful for classification; and outputting via the learning machine the most probable classification of the patient-specific structured data as a first pattern classification set in the form of a three dimensional graph (tri-graph).

In one embodiment, the method further comprises receiving at a semantic ontology processor a set of patient specific input data in the form of unstructured data including clinical narratives, written prescriptions, or notes written in free text; processing the unstructured data through a series of steps including filtering the data (for detection and correction of errors), sorting the data, for example through higher order labeling and indexing, to partition the data that can be used for pattern recognition, tokenization of the data, and lexicon verification against a standard collection of medical terms, for example SNOMED CT and ULMS, as defined herein below; converting the data into three dimensional vector space in the form of a three dimensional graph (tri-graph); extracting from the processed patient data a set of clinical variables associated with the psychiatric disorder; applying a pre-trained machine learning algorithm to the set of clinical variables wherein the machine learning algorithm is operative to identify the set of variables and associations that are meaningful for classification; and outputting via the learning machine the most probable classification of the patient-specific unstructured data as a second pattern classification set in the form of a three dimensional graph (tri-graph).

In one embodiment, the method further comprises receiving the first and second patient-specific pattern classification sets and integrating them together via a learning machine, preferably a support vector machine, using a multi-modal approach; and outputting the result as a patient-specific phenotype model for the psychiatric disorder.

In accordance with any of the foregoing embodiments where a learning machine is operative to identify a set of variables and associations that are meaningful for classification, the learning machine is further operative to weight the variables according to their relative significance (strength of association).

In accordance with any of the foregoing embodiments where unstructured data in the form of text is incorporated, natural language processing methods are utilized. In accordance with these embodiments, lexicon verification is used to verify the unstructured text-based data that is extracted automatically or semi-automatically, for example from the input patient-specific data. In a specific embodiment, a lexical filter is operative to perform the lexicon verification and the lexical filter comprises (i) a semantic taxonomy of nomenclature, for example OWL-2 as defined below, (ii) an ontology to put the nomenclature into a structured context that shows the relationships between the entities, (iii) a means for discriminating the undirected probabilistic graphical model, said means preferably taking the form of a conditioned random field which is used to encode known relationships between observations and construct consistent interpretations for labeling and parsing of sequential data, e.g., natural language processing of clinical text, and (iv) a validated training set that an SVM can use for making accurate correlations.

In accordance with any of the foregoing embodiments having a step of comparing a patient-specific phenotype model to a set of pre-defined phenotype models stored in the system knowledge discovery dataset (KDD) using three dimensional isograph pattern matching, the comparison step comprises three dimensional isograph pattern matching.

### BRIEF DESCRIPTION OF THE DRAWINGS

FIG. 1 is a system overview providing an illustrative schematic of components of the invention.

FIG. 2 shows data flow and modules (e.g., text mining modules) for natural language processing of unstructured information from clinical narratives and other text using medical ontologies extracted from the semantic web.

FIG. 3 shows a data mining module. Data flow and modules filter, sort and process structured data types. Included is the decision module that uses three dimensional (3D) isograph morphing to determine whether a patient diagnosed with PTSD or other psychiatric disease has a tri-graph that is homomorphic with 17 models stored in the endogenous KDD that span the most common phenotypes of a patient with anxious depression.

FIG. 4 shows the results of testing “Goodness of fit” for tri-graph homomorphism pattern matching.

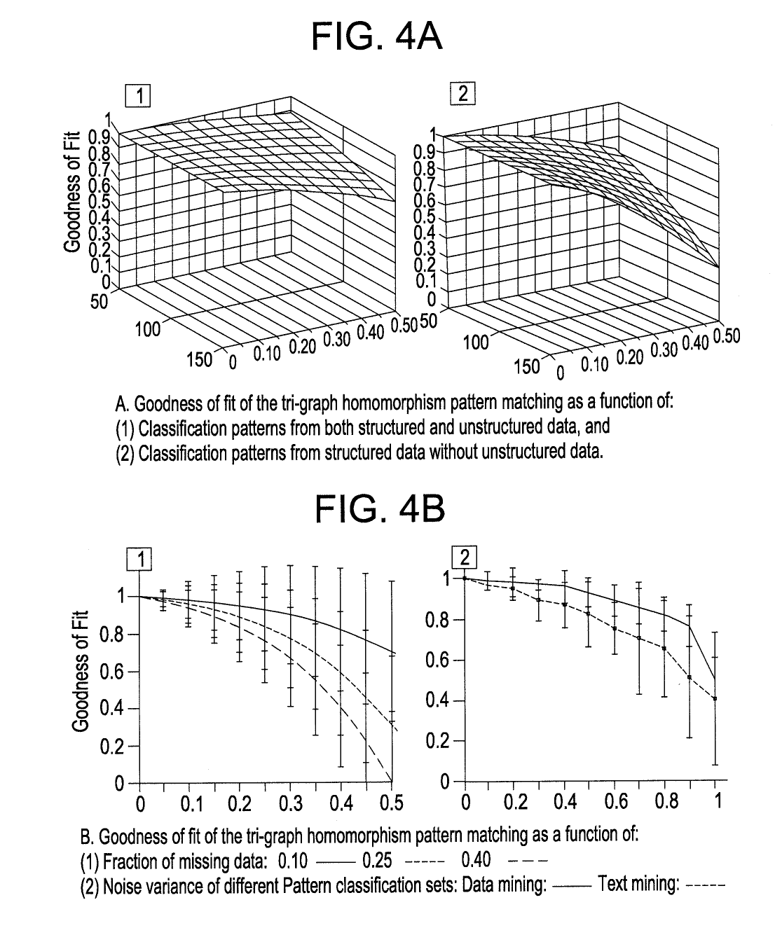

FIG. 5 shows a series of pre-defined phenotypic profile meta-models (tri-graphs). These graphs are examples of 3D tri-graphs that are a subset of the stored phenotype profiles in the endogenous KDD.

FIG. 6 shows a graphical representation of the method for semi-supervised machine learning of unstructured data using natural language processing and support vector machine models. Note 1 in the box labeled Conditioned Random Field refers to a discriminative undirected probabilistic graphical model. It is used to encode known relationships between observations and construct consistent interpretations. It is used for labeling and parsing of sequential data—in this case, natural language processing of clinical text.

FIG. 7 shows a graphical representation of the method for use of a medical ontology extracted from the semantic web for computer assisted clinical decision support.

FIG. 8 depicts a tri-graph isoform algorithm contained in the tri-graph generator that searches for a corresponding value in the stored pre-defined phenotype models for a match.

### DETAILED DESCRIPTION OF THE INVENTION

The systems and methods of the present invention provide a rapid and accurate means to combine heterogeneous data types, including unstructured data such as textual data, e.g., clinical narratives, written prescriptions, and notes written in free text, with structured data types such as genetic and epigenetic profiles and clinical variables such as can be obtained from an electronic health record (EHR). The systems and methods of the invention utilize this combination of data (which consists of molecular and clinical variables associated with a psychiatric disorder) to develop a set of meta-data profiles, e.g., PTSD phenotype models. The terms “meta-data profile”, “phenotype profile”, “phenotype model”, “set phenotype model” and “set phenotype” are used interchangeably in this context. The result is a high-quality set of phenotype models, each of which incorporates thousands of weighted co-variables. The present invention provides seventeen (17) pre-defined PTSD phenotype models characterized according to diagnosis, from least to most severe, as shown in Table 1. These pre-defined PTSD phenotype models are stored in the system of the invention in 3D isograph format in an endogenous knowledge discovery database (KDD). Each phenotype model is defined by a cluster of thousands of weighted co-variables.

TABLE 1
Seventeen most probable phenotypes for a PTSD patient observed from genotyping and
epiallele analysis conducted with 17,131 whole human genomes.

| MOST PROBABLE | | |
|---|---|---|
| OUTPUTS FROM | | Phenotype Profile Meta-Model for PTSD from least to most |
| WGA* | | severe. |
| 43 | 1 | Resilient, highest probability of remission, no treatment requirement |
| | | except for cognitive behavioral therapy (CBT) |
| 38 | 2 | Resilient, highest probability of remission with low dose sertraline or |
| | | paroxetine and CBT for less than a year |
| 35 | 3 | Very High Responders, requires moderate dose of sertraline or |
| | | paroxetine and CBT for 1-2 years to achieve remission |
| 29 | 4 | High Responders, requires sertraline or paroxetine and CBT for 1-2 |
| | | years to achieve remission plus acute treatment with FDA-approved |
| | | sedative-hypnotics for insomnia |
| 25 | 5 | Moderate Responders, require sertraline or paroxetine and CBT, |
| | | FDA-approved sedative-hypnotics for insomnia, low dose anti- |
| | | psychotics to achieve remission |
| 22 | 6 | Responders, require sertraline or paroxetine and CBT, FDA-approved |
| | | sedative-hypnotics for insomnia, low dose anti-psychotics to control |
| | | symptoms for definite period of time |
| 18 | 7 | Poor responders, require sertraline and paroxetine and CBT, FDA- |
| | | approved sedative-hypnotics for insomnia, low dose anti-psychotics |
| | | to control symptoms for an indefinite period of time |
| 16 | 8 | Poor responders, require sertraline and paroxetine and CBT, FDA- |
| | | approved sedative-hypnotics for insomnia, low dose anti-psychotics |
| | | to control symptoms, and other medications to control co-morbid |
| | | disease for a definite period of time |
| 14 | 9 | Poor responders, require sertraline and paroxetine and CBT, FDA- |
| | | approved sedative-hypnotics for insomnia, low dose anti-psychotics |
| | | to control symptoms, and other medications to control co-morbid |
| | | disease for an indefinite period of time |
| 13 | 10 | Poor responders, require sertraline and paroxetine and CBT, FDA- |
| | | approved sedative-hypnotics for insomnia, low dose anti-psychotics |
| | | to control symptoms, and other medications to control co-morbid |
| | | disease for an indefinite period of time, close monitoring for self- |
| | | harm |
| 11 | 11 | Poor responders, require sertraline and paroxetine and CBT, FDA- |
| | | approved sedative-hypnotics for insomnia, low dose anti-psychotics |
| | | to control symptoms, and other medications to control co-morbid |
| | | disease for an indefinite period of time, close monitoring for self- |
| | | harm and harm to others |
| 10 | 12 | Very poor responders, require poly-pharmacy with combinations of 2 |
| | | SSRI/SNRI medications (paroxetine, sertraline and venlaxafine XR) |
| | | and CBT, FDA-approved sedative-hypnotics for insomnia, anti- |
| | | psychotics to control symptoms, and other medications to control co- |
| | | morbid disease for an indefinite period of time, monitoring for self- |
| | | harm and harm to others |
| 8 | 13 | Very poor responders, require psychotropic poly-pharmacy with |
| | | combinations of 2 SSRI/SNRI medications (paroxetine, sertraline and |
| | | venlaxafine XR) and CBT, FDA-approved sedative-hypnotics for |
| | | insomnia, anti-psychotics to control symptoms, and other medications |
| | | to control co-morbid disease for an indefinite period of time, close |
| | | monitoring for self-harm and harm to others |
| 7 | 14 | Very poor responders, require psychotropic poly-pharmacy with |
| | | combinations of 2 SSRI/SNRI medications (paroxetine, sertraline and |
| | | venlaxafine XR) and CBT, FDA-approved sedative-hypnotics for |
| | | insomnia, anti-psychotics to control symptoms, and other medications |
| | | to control co-morbid disease for an indefinite period of time, close |
| | | monitoring for self-harm and harm to others |
| 4 | 15 | Extremely poor responders, require trial and error with range of |
| | | psychotropic drug combinations, FDA-approved sedative-hypnotics |
| | | for insomnia, anti-psychotics to control symptoms, and other |
| | | medications to control co-morbid disease for an indefinite period of |
| | | time, very close monitoring for self-harm and harm to others, CBT |
| | | not effective |
| 2 | 16 | Treatment-resistant, require trial and error with range of psychotropic |
| | | drug combinations, FDA-approved sedative-hypnotics for insomnia, |
| | | anti-psychotics to control symptoms, and other medications to control |
| | | co-morbid disease for an indefinite period of time, very close |
| | | monitoring for self-harm and harm to others, CBT not effective - any |
| | | experimental methods or other methods should be considered, |
| | | including TMS, ECT, periodic ketamine infusion, off-label drug |
| | | prescription of psychotropic drugs |
| 0 | 17 | Treatment-resistant, require in-patient hospitalization |

*WGA refers to “whole genome analysis”;
P < 0.0001 by ANOVA;
corrected for multiple testing as discussed in Auerbach, R. K. et al. Relating genes to function: Identifying enriched transcription factors using the ENCODE ChIP-Seq significance tool, Bioinformatics, advance access, 2009.

According to the methods of the invention, patient-specific data are utilized to create a phenotype model for the patient, which is also stored in 3D isograph format. The systems and methods of the invention utilize three dimensional isograph pattern matching to identify the best fit of the patient phenotype model to one of the pre-defined PTSD phenotype models in the system KDD. Thus, the systems and method of the invention are used to match the patient with a particular phenotype that indicates the severity of the patient's condition, and with the medications or other therapeutic interventions that are most strongly associated with a positive response for that particular phenotype, and thereby provide the psychiatric medication or therapy most likely to be successful for the patient based on current standards of practice. In one embodiment, the system provides a “best fit” with the totality of psychotropic drugs that are used in psychiatry. In another embodiment, the system provides an estimate of the probability of suicidal ideation or aggressive behavior. In another embodiment, the system predicts the psychiatric medication that is optimal for an individual patient diagnosed with a psychiatric disorder, preferably an anxiety disorder, a depression disorder, or PTSD.

In accordance with any of the embodiments of the invention, the psychiatric disorder is selected from an anxiety or depression disorder and the anxiety or depression disorder is selected from anxious depression or PTSD. The PTSD can be combat or non-combat PTSD. The PTSD can be acute, chronic or delayed-onset PTSD.

The systems and methods of invention may be implemented in numerous ways, including as a system, a process, an apparatus, or as a computer program. In one embodiment, the invention provides instructions and/or data (such as pre-defined phenotype models) included on a computer readable medium such as a computer readable storage medium or a computer network wherein program instructions are sent over optical or electronic communication links.

The systems and methods of the invention utilize a learning machine, trained according to the methods described herein, to derive associations (correlations) between the data variables and the severity of the diagnosis for the psychiatric disorder, and to assign appropriate weights to those variables. The data are mined from available structured, unstructured and/or semi-structured datasets representing clinical data, epigenomic data, and genomic data associated with the psychiatric disorder, preferably anxious depression or PTSD. Sources of structured genetic and epigenetic data include Pharmacogenomics Knowledge Base (PharmGKB), SNPedia, dbGaP, GEN2PHEN Knowledge Center, Genotator, GET-Evidence, NCBI GeneTests, and the Genetic Testing Registry. See Table 2. These web-based resources contain associations between genetic variations, associated phenotypes, and genetic tests. Semantic web sources of structured data include TMO, SO-Pharm, Pharmacogenomics Ontology (PO), Sequence Ontology (SO), GO, RxNorm, Logical Observation Identifiers Names and Codes (LOINC), ICD, Human Phenotype Ontology, Phenotypic Quality Ontology (PATO), DSM, Medical Dictionary for Regulatory Activities (MedDRA), Unified Medical Language System (UMLS), and Systematized Nomenclature of Medicine—Clinical Terms (SNOMED-CT). These semantic web resources are useful for the creation of a medical ontology-based processor for unstructured data, including text. See Table 3.

TABLE 2
Database resources containing structured data

| RESOURCE | DESCRIPTION |
|---|---|
| PharmGKB | A large database of curated knowledge and raw data about |
| | associations between genes, genetic variants, drug response |
| | and disease. |
| SNPedia | A wiki-based platform containing information on phenotypes |
| | associated with SNP variants, population prevalence of |
| | genetic variants and SNP microarrays. |
| dbGaP | Results of studies that have investigated the interaction of |
| | genotype and phenotype. |
| GEN2PHEN Knowledge | Integrated genotype-to-phenotype data with facilities for data |
| Center | annotation and user feedback. |
| Genotator | Aggregated gene-disease relationship data containing an |
| | integrated view over other datasets. |
| GET-Evidence | A large database of automatically annotated and then |
| | manually curated information about the impact of genetic |
| | variations. |
| NCBI GeneTests | This resource concerns genetic tests used in diagnostic and |
| | genetic counseling. |
| The Genetic Testing | A database about genetic markers and tests that enable their |
| Registry | clinical exploration. |

TABLE 3
Semantic web resources containing structured data

| DATA | | |
|---|---|---|
| RESOURCE | NAME | DESCRIPTION |
| Translational | TMO | An ontology covering key aspects of the entire |
| and | | spectrum of translational and personalized medicine, |
| personalized | | developed by participants of the W3C Heath Care |
| medicine | | and Life Science Interest Group. |
| PGx | SO-Pharm | An ontology that represents phenotype, genotype, |
| | | treatment and their relationships in groups of |
| | | patients. SO-Pharm has been designed to guide |
| | | knowledge discovery in pharmacogenomics |
| PGx | PO | An ontology built from PharmGKB that includes |
| | | biomedical measures and outcomes. |
| Genotype | SO | Contains terms often used for the annotation of |
| | | sequences and features, including detailed |
| | | description of different types of sequence variations. |
| Gene | GO | The Gene Ontology project is a major bioinformatics |
| | | initiative with the aim of standardizing the |
| | | representation of gene and gene product attributes |
| | | across species and databases. |
| Chemical | RxNorm | An established coding system for clinical laboratory |
| | | results. Contains many identifiers for results of |
| | | genetic tests. |
| Chemical, | LOINC | Normalized names for clinical drugs, references to |
| clinical | | other terminologies. |
| Phenotype | ICD | International Classification of Disease codes. |
| Phenotype | Human | An ontology for phenotypic abnormalities |
| | Phenotype | encountered in human disease. |
| | Ontology | |
| Phenotype | PATO | An general ontology of qualities that can be used to |
| | | describe phenotypes. |
| Phenotype | DSM | Diagnostic and Statistical Manual of Mental |
| | | Disorders codes. |
| Safety/toxicity | MedDRA | A terminology for safety reporting (mandated in |
| | | Europe and Japan for safety reporting, standard for |
| | | adverse event reporting in the USA). |
| Terminology | UMLS | The UMLS integrates and distributes key |
| | | terminology, classification and coding standards, |
| | | and associated resources to promote creation of |
| | | more effective and interoperable biomedical |
| | | information systems and services, including |
| | | electronic health records. |
| Terminology | SNOMED-CT | (Systematized Nomenclature of Medicine--Clinical |
| | | Terms) is a comprehensive clinical terminology, |
| | | owned, maintained, and distributed by the |
| | | International Health Terminology Standards |
| | | Development Organization (IHTSDO). |

The clinical data comprising the set of variables used to construct the phenotype models of the invention (e.g., patient-specific models and pre-defined phenotype models) includes at least three or more clinical co-variables selected from the group consisting of Age, Height, weight (Body Surface Area (BSA)), Ethnicity, Gender, Number of medications, Drug-Drug Interactions, Drug-Gene Interactions, Number of co-morbid psychiatric diseases, Number of co-morbid non-psychiatric diseases, Structured family history, Pittsburgh Insomnia Rating Scale (PIRS) Sleep Parameters Score. In one embodiment, the methods further include one or more clinical co-variables selected from the group consisting of the International Classification of Disease (ICD) codes, the Charlson index score, and one or more psychiatric scales selected from the group consisting of the Columbia Suicide Severity Rating Scale (see e.g., Posner et al. Columbia-suicide severity rating scale (C-SSRS) 2008, The Research Foundation for Mental Hygiene, Inc.), the Cincinnati Suicide Scale (see e.g., Sato et al. Cincinnati criteria for mixed mania and suicidality in patients with acute mania, Comprehensive Psychiatry, 2004; 45, 1:62-69), the Hamilton Rating Scale for Depression (HAM-D) (see e.g., The Hamilton rating scale for depression, J. Operational Psychiatry, 1979; 10(2):149-165), the 16-item Quick Inventory of Depression Symptomology (QIDS-C16) scale, the 9-item Patient Health Questionnaire (PHQ-9), the Clinical Global Impression of Severity (CGI-S; defined as a change in category of severity of at least 1 point), Clinical Global Impression of Improvement (CGI-I; defined as a score from 1 to 3), and Clinical Global Impression of Efficacy (CGI-EI; defined as scores of 01, 02, 05, or 06), or other similar psychiatric scale.

In one embodiment, the clinical co-variables comprise at least the set of clinical factors shown in Table 4 below.

TABLE 4
A classification set of clinical factors for regression

| INPUTS REQUIRED FOR THE | INDEPENDENT VALUES FOR PATTERN |
|---|---|
| ALGORITHM | CLASSIFICATION |
| Age | −20% per decade |
| Height, weight (Body Surface Area, | +11% per 0.25 m² |
| BSA) | |
| Ethnicity | −30% for African-Americans |
| | −17% for Caucasians (white) |
| Gender | +9% for females (prior to menopause) |
| Number of medications | Range from −15% to +15%, with the exception of |
| | significant drug-drug-gene-gene-variant interactions |
| Drug-Drug Interactions | Combinatorial range: To be determined for each |
| | medication and the ICD group(s) targeted for its |
| | classification |
| Drug-Gene Interactions | Combinatorial range: To be determined for each |
| | medication and the ICD group(s) targeted for its |
| | classification |
| Number of co-morbid psychiatric | Charlson index of 1 per psychiatric disease |
| diseases | |
| Number of co-morbid non-psychiatric | Charlson index of +1 to +4 per co-morbid disease, |
| diseases | depending on ICD classification |
| Structured family history | Data elements from the HL7 Clinical Genomics Family |
| | History Model, ranging from 0% to +50% |
| Pittsburgh Insomnia Rating Scale | Range from 0% to +30% |
| (PIRS); | |
| Sleep Parameters Score only | |

The epigenomic data comprising the set of variables used to construct the phenotype models of the invention includes the methylation state of a gene and in particular the degree of methylation density within the regulatory element of a pharmacogene. The epigenomic data comprising the set of variables used to construct the phenotype models includes at least one pharmacogene in the HPA stress response pathway. Preferably, the at least one pharmacogene is selected from the group consisting of ADCYAP1R1, ADRA2A, BDNF, CRHBP, CRHR1, FKBP5, HT2RA, NR3C1, NTRK2 and SLC6A4. Preferably, the genomic data includes at least three of the foregoing genes. In one embodiment, the regulatory element of the pharmacogene for which methylation density is assessed is selected from the group consisting of the first CpG island of ADCYAP1R1, Exon 1_{F} of NR3C1 promoter, intron 2 or intron 7 of FKBP5, cg22584138 of SLC6A4, and cg05951817 of SLC6A4. In one embodiment, the epigenomic data comprises the methylation density for each of the foregoing regulatory elements.

In one embodiment, where the psychiatric disorder is anxious depression or PTSD, the molecular co-variables include the methylation state of certain promoters such as the promoter of the 1F NR3C1 gene (encodes the human glucocorticoid receptor) and the glucocorticoid response elements (GRE) in the in the FKBP5 and SLC6A4 genes (Table 5). These show a linear correlation (r²=0.99) with severity and number of early childhood abuse and/or neglect as biomarkers for prediction of disorders of anxious depression, including PTSD, and refractory response to medication and/or therapeutic intervention.

In one embodiment, the epigenomic data comprises the classification set from ChIP-seq graphs of regulatory regions shown in Table 5 below.

TABLE 5
Classification set of regulatory regions for regression

| | | CORRECTED |
|---|---|---|
| | | VALUES FOR |
| GBRE IN GENE | β VALUE OF | PATTERN |
| REGULATORY REGION | METHYLATION | CLASSIFICATION |
| First CpG island of | 0.02 | 0% |
| ADCYAP1R1 | | |
| | 0.04 | +15% |
| | 0.06 | +30% |
| | 0.08 | +60% |
| | 0.1 | +60% |
| Exon 1_{F} of NR3C1 promoter | 0.02 | 0% |
| | 0.04 | +15% |
| | 0.06 | +30% |
| | 0.08 | +30% |
| | 0.1 | +60% |
| Intron 2/Intron 7 of FKBP5 | 0.02 | 0% |
| | 0.08 | +30% |
| | 0.1 | +60% |
| cg22584138 of SLC6A4 | 0.02 | 0% |
| | 0.04 | +8% |
| | 0.06 | +15% |
| | 0.08 | +30% |
| | 0.1 | +60% |
| cg05951817 of SLC6A4 | 0.02 | +8% |
| | 0.04 | +15% |
| | 0.06 | +15% |
| | 0.08 | +15% |
| | 0.1 | +30% |

The genomic data comprising the set of variables used to construct the phenotype models of the invention include the polymorphic status of a gene at a defined genetic variant such as a single nucleotide polymorphism (SNP) or a multi-nucleotide polymorphism (MNP). In one embodiment, the data includes at least one pharmacogene in the HPA stress response pathway. Preferably, the at least one pharmacogene is selected from the group consisting of ADCYAP1R1, ADRA2A, BDNF, CRHBP, CRHR1, FKBP5, HT2RA, NR3C1, NTRK2 and SLC6A4. Preferably, the genomic data includes at least three of the foregoing genes. In one embodiment, the SNP or variant is selected from the group consisting of ADCYAP1R1 rs2267735, ADRA2A rs6311, ADRA2A rs11195419, BDNF rs962369, CRHBP rs10473984, CRHR1 rs4792887, CRHR1 rs110402, FKBP5 rs3800373, FKBP5 rs1360780, FKBP5 rs9296158, HT2RA rs9316233, NR3C1 rs852977, NR3C1 rs6195, NR3C1 rs10052957, NR3C1 rs41423247, NTRK2 rs1439050, and SLC6A4XL28 variant selected from the XLA, LA, S, and LG variants. Preferably, the genomic data comprises at least three SNP or variants selected from the foregoing.

In one embodiment, the classification set of genomic data to be included in the phenotype models of the invention comprises or consists of the data in Table 6.

TABLE 6
SNP or MNP classification set of pharmacogenes to build PTSD phenotype models

| | SNP or | | Epigenome | Percent | Percent | |
|---|---|---|---|---|---|---|
| GENE | variant | Raw | variant | methylation | methylation | OUTPUT |
| ADCYAP1R1 | rs2267735 | +13% | | | | 1 |
| ADRA2A | rs6311 | +17% | | | | 3 |
| | rs11195419 | +11% | | | | |
| BDNF | | | Exon IV | 20% | 60% | 5 or 1 |
| | rs962369 | +22% | | | | |
| CRHBP | rs10473984 | +12% | | | | 1 |
| | | −44% | | | | |
| CRHR1 | rs4792887 | +13% | | | | 3 |
| | rs110402 | +9% | | | | |
| FKBP5 | rs3800373 | +27% | | | | 12 or 2 |
| | rs1360780 | +16% | rs1360780 A | 75% | 5% | |
| | rs9296158 | −23% | | | | |
| HT2RA | rs9316233 | +11% | | | | |
| NR3C1 | | | Exon 1F | 40% | 5% | 7 or 2 |
| | rs852977 | +42% | | | | |
| | rs6195 | +31% | | | | |
| | rs10052957 | | | | | |
| | rs41423247 | +44% | | | | |
| NTRK2 | rs1439050 | +43% | | | | 1 |
| SLC6A4 | XL28 variant | −45% | | | | 1 or 10 |
| | XLA or LA | −19% | | | | |
| | variant | | | | | |
| | S or LG | +27% | | | | |
| | variant | | | | | |

In one embodiment, the systems and methods of the invention include detecting the presence of at least one alteration or detecting the expression levels of at least one, at least two, at least three, at least four, at least five, or more genes whose protein product is involved in the absorption, distribution, metabolism, and elimination of a drug. Such genes are referred to as “ADME genes”. ADME proteins can be generally classified into three groups: phase I metabolizing enzymes, including the cytochrome P450 enzymes that carry out enzymatic oxidation, reduction and hydrolysis reactions; phase II metabolizing enzymes, which add endogenous compounds to the molecules after phase I metabolism and increase their solubility; and drug transporters, including efflux transporters and uptake transporters. Exemplary ADME genes include but are not limited to ABCB1 (ATP-binding cassette, sub-family B, member 1), ABCC2 (ATP-binding cassette, sub-family C, member 2), ABCG2 (ATP-binding cassette, sub-family G, member 2), CYP1A1, CYP1A2, CYP2A6, CYP2B6, CYP2C19, CYP2C8, CYP2C9, CYP2D6, CYP2E1, CYP3A4, CYP3A5, DPYD (dihydropyrimidine dehydrogenase), GSTM1 (glutathione S-transferase M1), GSTP1 (glutathione S-transferase pi), GSTT1 (glutathione S-transferase theta 1), NAT1 (N-acetyltransferase 1 (arylamine N-acetyltransferase)), NAT2 (N-acetyltransferase 2 (arylamine N-acetyltransferase)), SLC15A2 (solute carrier family 15, member 2), SLC22A1 (solute carrier family 22, member 1), SLC22A2 (solute carrier family 22, member 2), SLC22A6 (solute carrier family 22, member 6), SLCO1B1 (solute carrier organic anion transporter family, member 1B1), SLCO1B3 (solute carrier organic anion transporter family, member 1B3), SULT1A1 (sulfotransferase family, cytosolic, 1A, phenol-preferring, member 1), TPMT (thiopurine S-methyltransferase), UGT1A1 (UDP glucuronosyltransferase 1 family, polypeptide A1), UGT2B15 (UDP glucuronosyltransferase 2 family, polypeptide B15), UGT2B17 (UDP glucuronosyltransferase 2 family, polypeptide B17), and UGT2B7 (UDP glucuronosyltransferase 2 family, polypeptide B7).

In one embodiment, the systems and methods of the invention further include detecting the presence of at least one alteration or detecting the expression levels of at least one, at least two, or at least three cytochrome P450 genes, or a combination thereof. In one embodiment, the at least one cytochrome P450 gene is selected from the group consisting of CYP1A1, CYP1A2, CYP1B1, CYP2A6, CYP2A7, CYP2A13, CYP2B6, CYP2C8, CYP2C9, CYP2C18, CYP2C19, CYP2D6, CYP2E1, CYP2F1, CYP2J2, CYP2R1, CYP2S1, CYP2U1, CYP2W1, CYP3A4, CYP3A5, CYP3A7, CYP3A43, CYP4A11, CYP4A22, CYP4B1, CYP4F2, CYP4F3, CYP4F8, CYP4F11, CYP4F12, CYP4F22, CYP4V2, CYP4X1, CYP4Z1, CYP5A1, CYP7A1, CYP7B1, CYP8A1, CYP8B1, CYP11A1, CYP11B1, CYP11B2, CYP17A1, CYP19A1, CYP20A1, CYP21A2, CYP24A1, CYP26A1, CYP26B1, CYP26C1, CYP27A1, CYP27B1, CYP27C1, CYP39A1, CYP46A1, and CYP51A1.

In one embodiment, the systems and methods of the invention comprise detecting a genetic polymorphism in at least three cytochrome P450 genes consisting of CYP2D6, CYP2C19, and CYP1A2. In one embodiment, the methods comprise detecting a genetic polymorphism in at least three cytochrome P450 genes consisting of CYP2D6, CYP2C19, and CYP1A2 and the serotonin transporter gene, SLC6A4 (also referred to as 5HTTR) and the serotonin 2A receptor, HTR2A.

The systems and methods of the present invention integrate clinical, epigenomic, and genomic data in both structured and unstructured formats to optimize medication selection in a patient-specific manner by classifying the patient into one of a set of pre-defined phenotype models, the phenotype model indicating the diagnostic phenotype of the patient and the medication for administration to the patient. In this system, unstructured data and structured data are obtained from different sources, including laboratory tests, electronic health records, computerized physicians order entry (CPOE) systems, clinical narrative and notes, and any such healthcare data that are deemed necessary to make a diagnostic decision, even those from a plurality of sources with heterogeneous data types, are accommodated by this invention. The system and methods of the invention process this data and integrate it to optimize clinical decision support, for example to select the drug(s) that have the highest probability of a positive therapeutic outcome for a particular patient. The methods comprise creating a patient-specific phenotype model and classifying the patient according to that phenotype model by comparison to a set of pre-defined phenotype models. The pre-defined phenotype models and the patient-specific phenotype models generated by the methods of the invention thus integrate both structured and unstructured data. The phenotype models are generated using one or more learning machines, preferably a support vector machine (SVM). In accordance with the methods of the invention, the phenotype models (and the pattern classification sets from structured and unstructured data which are integrated to form a phenotype model) can be evaluated as to selection logic using metrics similar to those used for information retrieval tasks. These include sensitivity (recall), specificity, positive predictive value (PPV, also known as precision), and negative predictive value. If a population is assessed for case and control status, then another useful metric is comparing the receiver operator characteristic (ROC) curves. ROC curves graph the sensitivity vs. false positive rate (or, 1-specificity) given a continuous measure of the outcome of the algorithm. By calculating the area under the ROC curve (AUC), one has a single measure of the overall performance of an algorithm that can be used to compare two algorithms or selection logics. Since the scale of the graph is 0 to 1 on 3 axes, the performance of a perfect algorithm is 1.5, and random chance is 0.5.

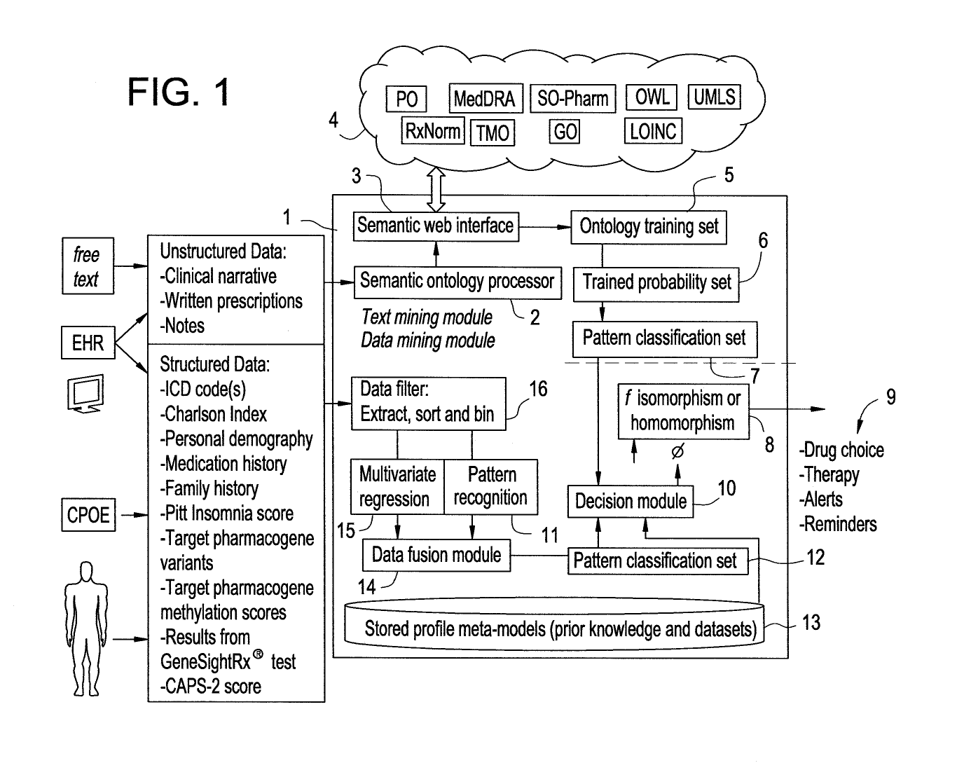

FIG. 1 is a simplified block diagram of an exemplary system of the invention. As shown in the figure, incoming data can enter the system via two different routes, based on whether the data are in the form of structured or unstructured data types 1.

For unstructured data such as text, the data is transmitted to the Text mining module, where it is processed using a Semantic ontology processor 2. The Semantic ontology processor uses a machine learning method to extracts data through a Semantic web interface 3 from a plurality of medical ontologies from the web 4. These data are used to create ontology from the semantic web to form an Ontology training set 5 which undergoes an unsupervised machine learning process. The Semantic ontology processor 2 searches input material for a disease or other terms of interest. Once the input material disease or other terms of interest are located in the ontology, the terms from the desired relationships are also identified. The type of relationship, distance (e.g., number of intervening terms), direction of link, or other restriction may be used to determine associated terms. The associated terms are collected and placed into the Ontology training set 5. The collected set may be used automatically in a “leave one out” approach to identify desired results, such as selecting only terms associated with a sufficient probability based on training.

The semantic web contains medical ontologies, such as Web Ontology Language (OWL), Gene Ontology (GO), Medical Subject Headings (MeSH) and Unified Medical Language System (UMLS), that provide relationship information for various terms. The Semantic Web technologies produced by the World Wide Web Consortium (W3C) facilitate the representation and processing of datasets containing increasingly sophisticated knowledge. Hundreds of datasets have been linked in this way, resulting in a global cloud of interlinked data. The ontologies provide a hierarchy of concepts wherein general concepts appear higher in the ontology—“is a” ontologies wherein each child “is a” more specific instance of its parent (e.g., “PTSD” is a kind of “Psychiatric disease”). Ontologies also contain additional information about morphology, symptoms, associated drugs, side effects, causes, or other relationships. All or some of this information enriches the probabilistic decision support system, for instance, by semi or automatically building the probabilistic network. Probability values are assigned to the terms from the medical ontology. Once the term structure is defined, a large pool of patient cases is used to learn these probabilities. The learning may be automatic with no manual input, or semi-automatic with user seed term catalysis, user tuning, or minimal manual input. To ensure quality control, the Trained probability set 6 is checked in an iterative fashion by the endogenous KDD 13 (FIG. 1).

Ontologies and terminologies play a critical role in data integration. They enable the use of well-defined, unambiguous terms to semantically annotate data, thereby providing the means by which one can query across different datasets that use the same terms. Terminologies and coding systems focus on providing a comprehensive set of terms. By contrast, ontologies are a formal representation for specifying the entities and attributes, as well as their relations, in a domain of discourse (such as pharmacogenomics). When ontology is expressed in Web Ontology Language (OWL), automatic reasoning can be performed in a predictable fashion. By ameliorating the complexity and heterogeneity of data representation, ontologies enable a separation of layers between pharmacogenomic knowledge, on the one hand, and both business rules of regulatory guidelines and clinician-facing application, on the other. The ontologically enabled knowledge layer then can be managed to track scientific advances independently of the other layers. The coverage of genetic information in established clinical coding schemes and ontologies varies. For example, Logical Observation Identifiers Names and Codes (LOINC) is an established standard for representing clinical laboratory results.

Referring again to FIG. 1, for text data mining using natural language processing, the Semantic ontology processor 2 generates a domain knowledge base from associated terms. The terms included depend on the domain, such as using only terms associated with a specific psychiatric disease. Alternatively, a predefined set of terms such as those obtained from an existing algorithm can be incorporated to establish a domain knowledge base in the absence of in addition to those associated terms defined by Semantic ontology 2. The domain knowledge base is a list of the associated terms.

Thus, the present invention provides methods for text mining which utilize the semantic web to extract medical ontologies to develop a probabilistic training set from processed unstructured data. The unstructured data can be free text. The probabilistic training set is used in an iterative natural language method to train the set with pre-existing data models accessed from an endogenous knowledge discovery database (KDD).

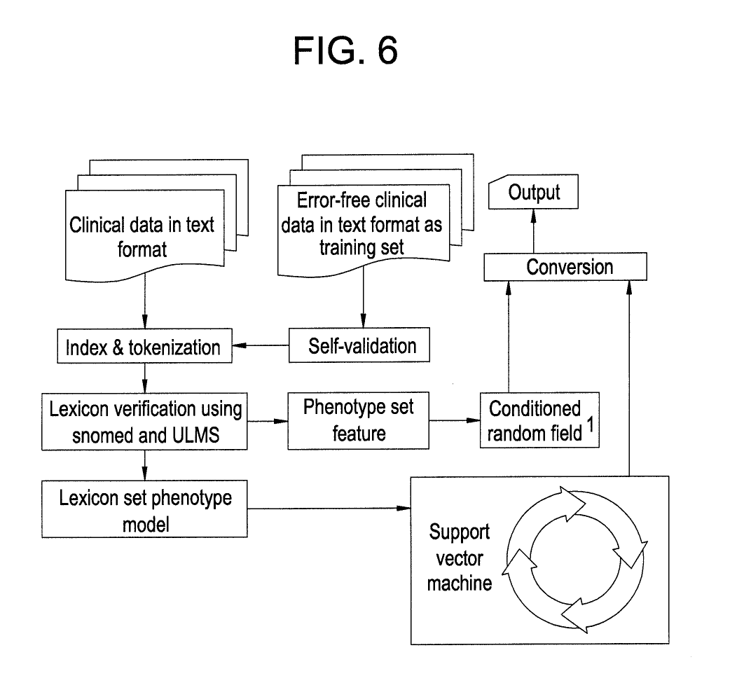

In one aspect, the system of the invention generates models that can be used to interpret the real world phenomena of the language structures and clinical knowledge in the text. The system also enables the optimal classifier from a set to be assessed in different applications. The required extraction models are built, for example, using training data and local knowledge resources. The data extracted for the probabilistic training set is preferably checked for inconsistencies between annotations by using a reflexive validation process, which is denoted as ‘100% train and test’. This involves using 100% of the training set to build a model and then testing on the same set. With this self-validation process, error detection in the training data can be improved until an asymptote is reached. The three most frequent error types in concept annotation are: (1) missing modifier (any, some); (2) including punctuation (full stop, comma, hyphen); (3) missing annotation (false negative). As theoretically all data items used for training should be correctly identifiable by the model, any errors represent either inconsistencies in annotations or weaknesses in the computational linguistic processing. The former faults identify training items that are rejected, and the latter gives indications of where to concentrate efforts to improve the preprocessing system. This process improved scores of the order of 0.01%. See FIG. 6.

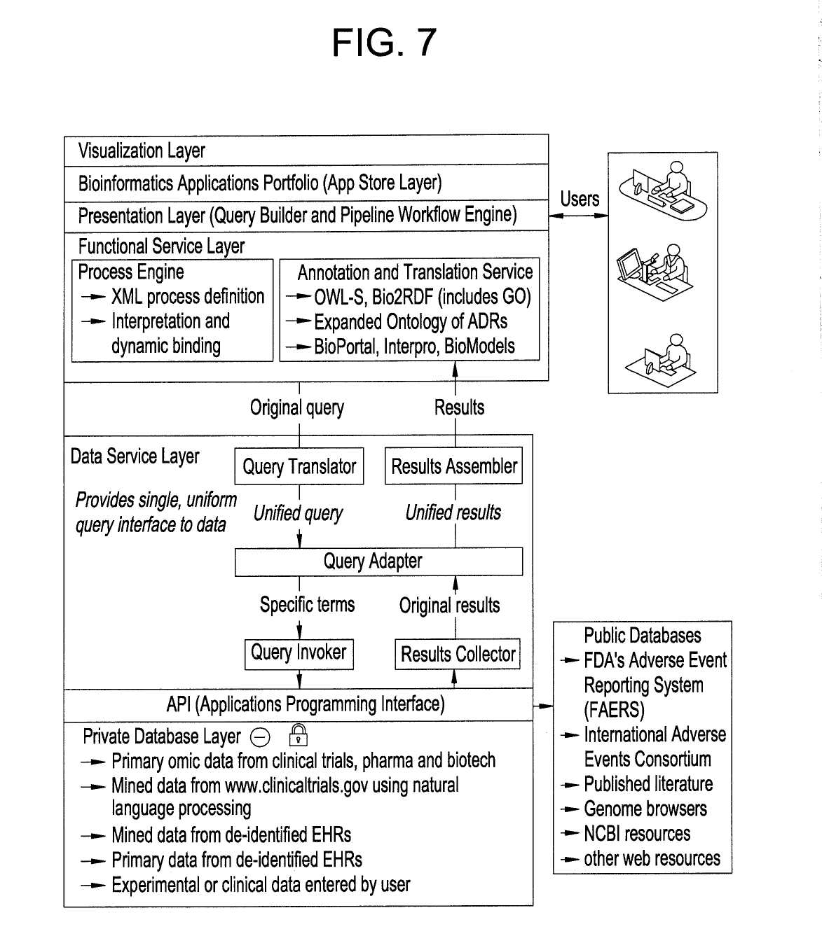

In one aspect, the systems and methods include a query-based, faceted search framework in the cloud, a Service Oriented Architecture (SOA), access to private/proprietary data as might be contained in primary data sources such from pharma, biotech, academia & publishers through a pre-competitive data-sharing community, access to NLP-processed text from both longitudinal de-identified EHRs and at Clinical Trials dot gov., access to public resources in the cloud, including e.g., FAERS and iAEC, published literature, and NCBI resources, and a heterogeneous database service, based on standards such as OWL-S (ontology web language service) and RDF. The system is shown graphically in FIG. 7.

A medical ontology indicates one or more semantic groupings of features. A processor learns to identify at least one similar patient profile from a set of stored patient profiles based on an existing and continually updated endogenous knowledge discovery database (KDD). A memory is operable to store machine-learnt algorithms. The machine-learnt algorithms integrate multi-level medical ontology. The multi-level medical ontology has a hierarchal structure defining relative contribution of features at different levels of the multi-level medical ontology. A processor is operable to apply machine-learnt algorithms to the medical profile of a patient. The learning is a function of the one or more semantic groupings of features of the medical ontology. Information derived from the learning is output that represents the most probable classification of data. That output is expressed as a Pattern classification set 7. Structured data are filtered, sorted, and processed based on data type and they are fused into a Pattern classification set derived from the Data Mining Module.

The present invention also provides a method for the development of a lexicon set phenotype model built from published data and research, which encompass the most commonly encountered PTSD patient phenotypes in terms of clinical, genomic and semantic descriptors. In accordance with the invention, these models are data-rich, three dimensional (3D) tri-graphs. The present invention also provides a reference set for subsequent pattern matching produced by the methods described herein.

The lexicon set phenotype model is a system developed to store the accumulated lexical knowledge laboratory and contains categorizations of spelling errors, abbreviations, acronyms and a variety of non-tokens. It also has an interface that supports rapid manual correction of unknown words with a high accuracy clinical spelling suggestor plus the addition of grammatical information and the categorization of such words. After lexical verification, feature sets were prepared to train a CRF model to identify the named entities, classes of problems, tests and treatments. For classification, several methods were tested and the best method was the CRF with feature sets. SVM classified relationships between entities using local context feature and semantic feature sets. All feature sets were sent to corresponding CRF and SVM feature generators. Finally, when the results from CRF, SVM were computed, the conversion system generated the outputs according to the format required for use in the three dimensional vector space of the trigraph generator. Conversion was performed using a modification of the i2b2 conversion tool (see A. Abend et al. “Integrating Clinical Data into the i2b2 Repository” Summit on Translat Bioinforma. 2009 1-5). It differs in that the rule-based method was converted to a statistical method for both CRF and SVM tests for pattern-matching in the three dimensional vector space of the trigraph generator.

Referring again to FIG. 1, for diagnosis support, a Trained probability set 6 is built from the associated terms and/or relationship information of the Ontology training set. For example, a Bayesian network, a conditional random field, an undirected network, a hidden Markov model and/or a Markov random field is trained by the Semantic ontology processor 2. Preferably a conditional random field is utilized in the methods of the invention for the natural language processing of clinical text (see e.g., FIG. 6). In a preferred embodiment, the resulting model is a vector model with a plurality of variables represented in three dimensional vector space. Other representations may be used such as single level or hierarchal models. For training, both training data and ontologies information are combined.

A probabilistic decision support system is formed from the medical ontology to develop a Trained probability set 6. The probabilistic Trained probability set may operate independently of or be incorporated into a data mining system. In an exemplary embodiment, the natural language processing involves iterative training of semantic web medical ontology with an existing, endogenous KDD 13 using semantic groupings combined with multi-level ontology data from the KDD 13, with weighting of the groupings based on the prior knowledge and datasets contained in the KDD 13. This output is a Trained probability set 6 which is rendered into a computer readable Pattern classification set 7 of the same indexed structure as the Pattern classification set 12 that is contained in the Data mining module of the system. The Pattern classification set 7 is then transferred into the Decision module 10 of the Data mining module shown in FIG. 1.

Referring to FIG. 1, in the context of the Data mining module, the terms data, information, and knowledge are used interchangeably. For brevity, the term “information” as used in this context should be understood to refer to the complete range of data, information, and knowledge.

The Data mining module receives input of structured data types. Structured data types used in the methods of the invention may include, without limitation, International Classification of Disease (ICD) codes, results from the GeneSightRx® psychotropic test (AssureRx Health, Inc.), Charlson Index or other structured scores of the extent of co-morbidity, structured family history reports, and epigenomic, genomic, transcriptomic, proteomic and metabolomic data generated from the user's research, the published literature, or other sources including those from the interne can be routed to the Data mining module. Table 2 shows database resources on the web that contain associations between genetic variations, associated phenotypes, and genetic tests. Table 3 shows semantic web resources for the creation of a medical ontology-based processor for unstructured data, including text.

The Data filter 16 defines, detects and corrects errors in given data, in order to minimize the impact of errors in input data on succeeding analyses. It also transforms the structured data so that it can be sorted into a multivariate regression algorithm 15 or into Pattern recognition 11 (FIG. 1).

Data sorting can be accomplished using a variety of different algorithms, but the goal is to partition the data that can be used for regression analysis 15 and data types that have to be analyzed by pattern recognition 11 (FIG. 1). The best approach is by higher-order labeling and indexing.

Pattern Classification and Pattern Classification Sets

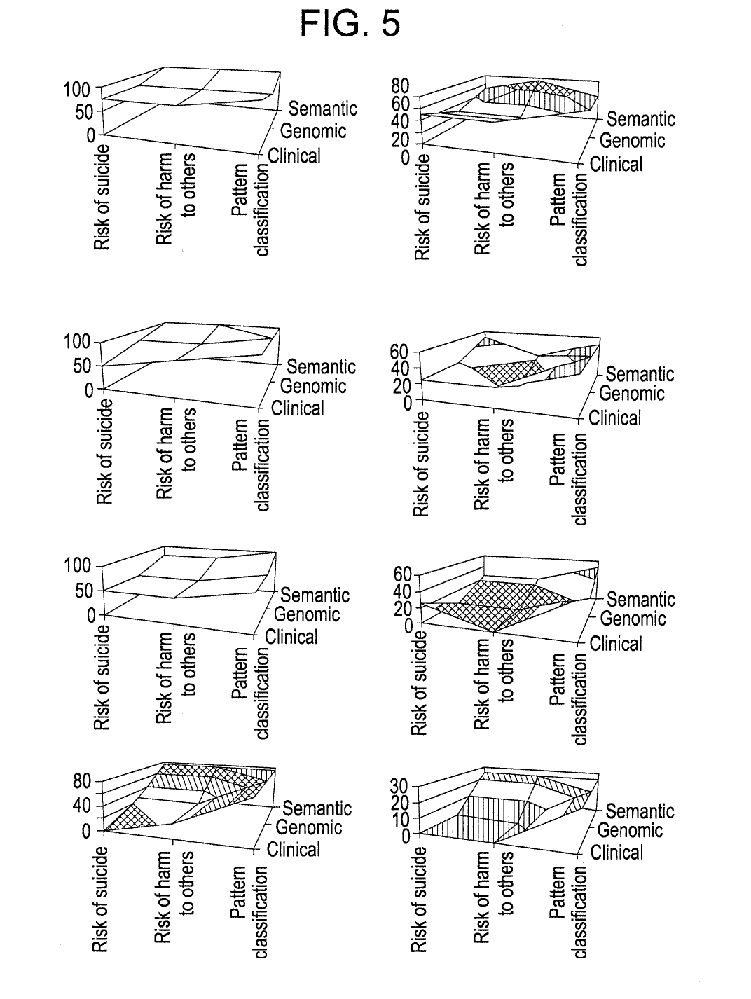

The methods of the invention include the generation of at least two pattern classification sets, one from unstructured text data and one from structured data. These are depicted graphically in FIG. 1 as Pattern classification set 7 and Pattern classification set 12. Each of these pattern classification sets is represented in three dimensional vector space in the form of a three dimensional graph (tri-graph). The two pattern classification sets are integrated into a single phenotype model which is also in the form of a tri-graph. In one aspect, the phenotype model is built from patient-specific input data. In this context, the phenotype model may be referred to as the patient's set phenotype or set phenotype model. In a second aspect, the phenotype model is a pre-defined phenotype model. The phenotype models are stored in the system endogenous KDD 13 (FIG. 1). In one embodiment, the endogenous KDD 13 contains seventeen (17) stored pre-defined PTSD phenotype models representing the range of clinical, genomic and semantic models that can be configured using available data such as the data shown in Tables 1, 4, and 6. These PTSD phenotype models are numerical models configured as tri-graphs to be used for comparison with actual patient data and for decision-making (see e.g., FIG. 5).

In the context of the structured data, the pattern classification set is based upon structured data received by the data mining module. The data is processed through a series of steps including extracting, sorting and binning the data; applying a pattern recognition algorithm to the processed data; and finally outputting the most probable classification of the structured data as a pattern classification set in the form of a three dimensional graph (trigraph).

The pattern recognition algorithm is applied by the Pattern recognition module 11 (FIG. 1). Techniques for analyzing and synthesizing complex knowledge representations (KRs) may utilize an atomic knowledge representation model including both an elemental data structure and knowledge processing rules stored as machine-readable data and/or programming instructions. Statistical pattern recognition can be used to classify patterns based on a set of extracted features and an underlying statistical model for the generation of these patterns. One approach is to determine the feature vector, train the system and classify the patterns. Clustering algorithms are used extensively not only to organize and categorize data, but are also useful for data compression. A common element of cluster analysis for pattern recognition is to identify cluster centers as a way to tell where the heart of each cluster is located, so that later when presented with an input vector, the system can tell which cluster this vector belongs to by measuring a similarity metric between the input vector and all the cluster centers, and determining which cluster is the nearest or most similar one. Hierarchical clustering of the data builds a cluster hierarchy or, in other words, a tree of clusters, also known as a dendrogram, such as applied in psychiatric genomic drug discovery (Altar et al. (2008) Insulin, IGF-1, and muscarinic agonists modulate schizophrenia-associated genes in human neuroblastoma cells. Biol. Psychiatry, 64: 1077-1087). Every cluster node contains child clusters; sibling clusters partition the points covered by their common parent. The approach here is to start with a big cluster, recursively divide this large cluster into smaller clusters, and stop when k number of clusters is achieved. Another approach is K-means clustering, which aims to partition n observations into k clusters in which each observation belongs to the cluster with the nearest mean. The algorithm is called k-means, where k is the number of desirable clusters, since a case is assigned to the cluster for which its distance to the cluster mean is the smallest. The action in the algorithm centers on finding the k-means. This algorithmic approach starts with an initial set of means and classifies cases based on their distances to the centers. This is repeated until an asymptotically small rate of change in cluster means occurs between successive steps. Then, calculation of the means of the clusters can assign the cases to their permanent clusters. The K-mean algorithm is a popular clustering algorithm and has its application in data mining, image segmentation, bioinformatics and many other fields. This algorithm works well with small or large, well-defined datasets. Modified k-mean algorithm avoids getting into locally optimal solution in some degree, and reduces the adoption of cluster-error criterion.

Algorithm: Modified K-means (S, k), S = {x1, x2, . . . , xn}

Input: The number of clusters k1(k1 > k) and a dataset containing n
objects (Xij+)
Output: A set of k clusters (Cij) that minimize the Cluster - error
criterion.
1. Compute the distance between each data point and all other data points
in the set D;
2. Find the closest pair of data points from the set D and form a data point
set Am (l <= p <= k) which contains these two data points. Delete these
two data points from the set D;
3. Find the data point in D that is closest to the data point set Ap. Add it to
Ap and delete it from D;
4. Repeat step 3 until the number of data points in Am reaches (n/k);
5. If p < k, then p = p + l. Find another pair of data points from D
between which the distance is the shortest. Form another data-point set Ap
and delete them from D.
Go to step 4
Algorithm 1
For each data point set Am (l <= p <= k) find the arithmetic mean of the
vectors of data points Cp(l <= p <= k) in Ap.
Select nearest object of each Cp(l <= p <= k) as initial centroid.
Compute the distance of each data point di (l <= i <= n) to all the
centroids cj (l <= j <= k) as d(di, cj)
For each data point di, find the closest centroid cj and assign di to cluster j
Set ClusterId[i] = j; // j: Id of the closest cluster
Set Nearest_Dist[i] = d(di, cj)
For each clusterj (l <= j <= k), recalculate the centroids
Repeat
Algorithm 2
1. For each data-point di
Compute its distance from the centroid of the present nearest cluster
If this distance is less than or equal to the present nearest distance, the
data-point stays in the cluster
Else;
For every centroid cj (l <= j <= k) Compute the distance (di, cj); Endfor
Assign the data-point di to the cluster with the nearest centroid Cj
Set ClusterId[i] = j
Set Nearest_Dist[i] = d (di, cj); Endfor
2. For each cluster j (l <= j <= k), recalculate the centroids; until the
convergence Criteria is met.

The Data fusion module 14 (FIG. 1), integrates data from the regression analysis and cluster analysis using a multi-modal approach as described in Chen (Chen, C. L., et al., 2012. Mobile device integration of a fingerprint biometric remote authentication scheme. Int. J. Commun. Syst., 25: 585-597) to fuse image, video and text data. Shrinkage-optimized data assessment fuses multi-modal data by estimation of the joint probability distribution of audio and visual features. The Shrinkage-optimized data assessment (SODA) estimator is completely data-driven, and can accommodate the datasets resulting from regression analysis and pattern recognition. The algorithm is described in detail in Chen. This approach can be used for the fusion of structured, heterogeneous data types, resulting in a Pattern classification set 12 (FIG. 1) that is configured as a tri-graph.

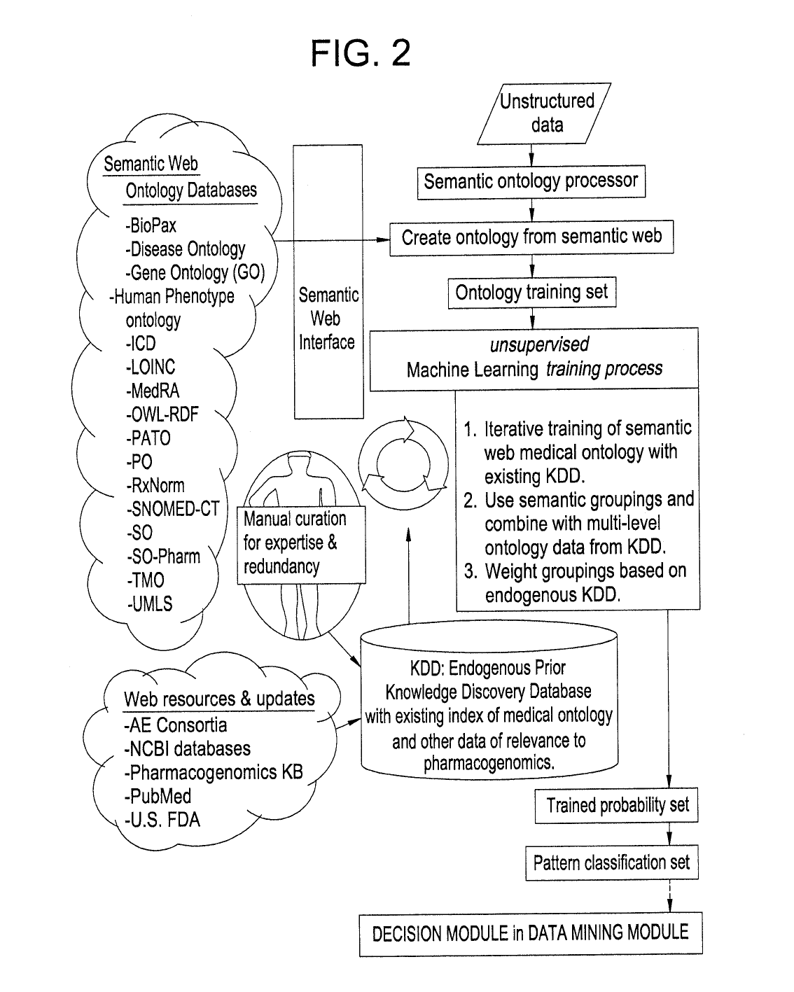

The Decision module 10 receives the Pattern classification set 7 from the Text mining module (FIG. 2) and the Pattern classification set 12 from the Data mining module (FIG. 1-2).

Pattern classification sets from both unstructured and structured data take the form of a three dimensional graph that is matched against a discrete set of stored, most probable phenotype profiles represented as three dimensional graphs (tri-graphs). The learning machine generates the pattern classification sets and phenotype models in the form of three dimensional graphs, or tri-graphs. The visual representation that is produced is called a diagram. The algorithm for achieving this includes: (1) Ordering graph vertices—Rank or sort them into an order that is based on their connectivity; (2) Position vertices using the order; (3) Automatically route and draw edges; and (4) Display graph. Edges are added in a way that clearly exhibits vertices without adding clutter or artifacts. Therefore a route for the edge must be found, and exhibit the following characteristics—it should (1) always chose the shortest path for pattern matching; and (2) avoid other vertices in graph. The output Pattern classification tri-graphs are compared by the Decision module 10 in a pair-wise manner to the stored, reference tri-graphs. The degree of “best fit” homomorphism within limits provides a match that is expressed as an output for medication selection and/or therapy that is a function of the stored phenotype profile.

Graph Isomorphism for Patient Classification

The present invention provides methods to process structured clinical, epigenomic, and gene variant data from a new input patient profile using pattern matching in three dimensional vector space. According to the invention, the phenotype models are assessed using isomorph graphing to match the pattern of a new input patient profile to one of a set of pre-defined phenotype models. In one embodiment, the decision regarding optimal drug choice (and therapy) for a given patient is based on best fit to one of the seventeen PTSD phenotype models stored in the endogenous KDD of the system defined by the invention.

Graph isomorphism is the problem of testing whether two graphs are really the same. In the context of the present invention, the graphs are trigraphs containing multivariate data that has been converted into three dimensional vector space. There are many algorithmic approaches to pattern-matching 2D isographs. The present invention utilizes a novel extension of two-dimensional graph isomorphism to compare the three dimensional tri-graph phenotype models of the invention. The present invention extends two-dimensional graph isomorphism to three dimensional vector space and adds shader technology (see Kiang, T. et al. “Integrating Advanced Shader Technology for Realistic Architectural Virtual Reality Visualization” Computer-Aided Architectural Design Futures (CAADFutures) 2007, pp 431-443) in order to fit as much data as possible into the 3D isograph without violating the ‘nearest neighbor’ requirement of pattern matching. For example, starting from a ‘curved manifold’ in a 2D isograph (see e.g., FIG. 2 of Ghazvininejad et al. “Isograph: Neighborhood Graph Construction Based on Geodesic Distance for Semi-Supervised Learning” Data Mining (ICDM), 2011 IEEE 11th International Conference, 191-100 (2011), each of the 2D manifold coordinates can be extended into three dimensions using vectors that are perpendicular to all points on the manifold. Although this is not a trivial computation, the addition of shaders means permits the loading of all data into each of the 17 pre-trained phenotype 3D isographs. Pattern matching is then performed. Any missing data values from the input patient data are filled in from the set phenotype models using highest probability scoring.

The three dimensional tri-graph phenotype models of the invention are three-dimensional, data-geometric graphs which can be realized in terms of comparisons of geometric configuration. First, graph alignment is effected making use of an optimization approach whose cost function arises from a diffusion process between the vertices in the graphs under study. Second, a probabilistic approach to recover the transformation parameters that map the vertices on the pre-defined, phenotype model graph onto those on the data graph produced as a transformation of the Pattern classification set. Transformation parameters that map the graph-vertices to one another permit the computation of a similarity measure based upon the goodness of fit between the two graphs under study. Thus, the algorithm is effective in matching two graphs belonging to the same class.

A tri-graph G with p nodes can be converted to an adjacency matrix according to the following method: (1) Number each node in a 3D contour by an index {1, . . . , p}. Represent the existence or absence of a contour as Adj (x, y, z)=1 if G contains contours x, y and z, but 0 otherwise. (2) Consider three graphs G1={x1, y1, z1}, G2={z2, y2, y2} and G3={x3, y3, y3} (3) A homomorphism from G1 (reference meta-model) to G2 and G3 is mapped in a step-wise manner. (4) Any of the tri-graphs G2 and G3, produced by the Pattern classification sets from the Text mining module and the Data mining module respectively, is rejected if the mapped graph contour space differs in any dimension by ±10%. (5) Any such tri-graph outside of these limits is transferred back to the endogenous KDD for subsequent further analysis.

If there is homomorphism within limits for G2 and G3 to one of the seventeen pre-defined phenotypic profile meta-model tri-graphs 8 (FIG. 1), then a decision is made on what medication(s) to select and what course of therapy to follow, based on medical outcomes-based evidence that was to configure the seventeen different pre-defined phenotypic models.

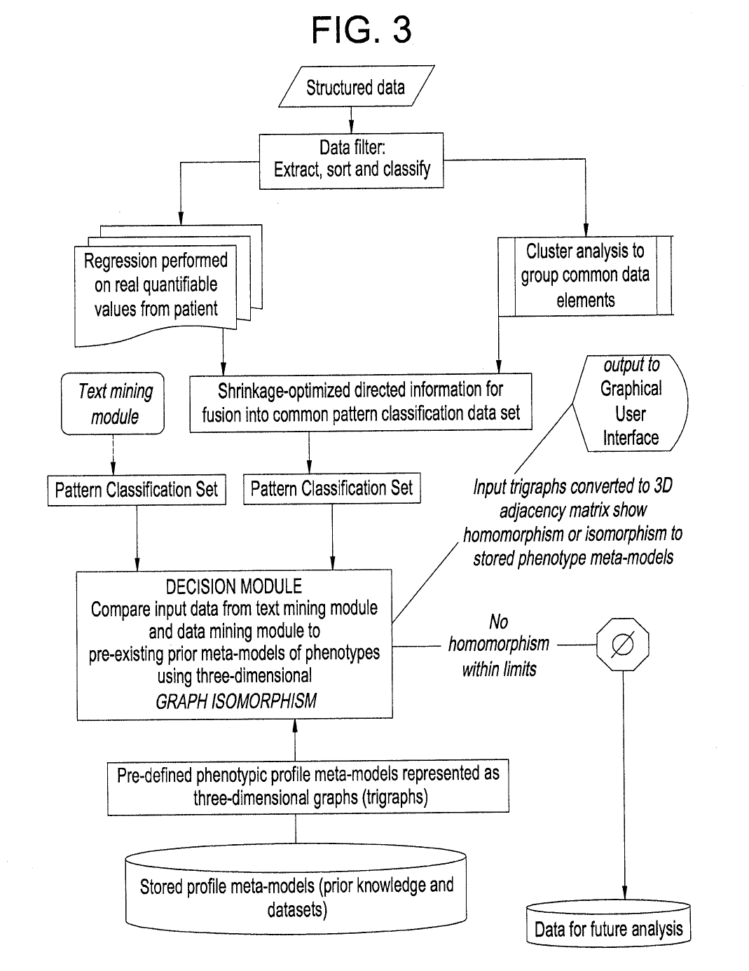

Once an adequate fit-to-model has been made, it represents the “decision” from this clinical decision support system. Recommendations, alerts and reminders are sent as output to a computer-based graphical user interface 9 (FIGS. 1 and 3).

The system of the present invention also provides for clinical decision support based on data derived from a genome-enabled electronic health record. Molecular, clinical and semantic variables can be extracted from a complex plurality of data types and coalesced into a discrete pattern-matching algorithm that provides the best clinical decision based on the current state-of-the-art in genomics and other variables. In this embodiment, the system must support inputs from the electronic health record, computerized physician order entries, and other structured data. For unstructured data types, which might take the form of clinical notes and written prescriptions or orders in free text, a semantic processor must support a secure semantic web interface that links to the semantic web for the development of a pattern classification set that is derived through iterative training by knowledge, data and information stored in a local database, to create an ontology training that forms the most probable set for pattern matching. When the phenotypic profile of a patient matches that of a locally-stored phenotypic profile, derived from the best available knowledge, a decision is sent to an output that takes the form of a graphical user interface that may constitute an embedded screen in an existing electronic health record system, health information exchange display, secure web service or mobile health device such as a cell phone, computer tablet or other device that displays health data.

In one embodiment, the system of the invention may be configured as a research database for use by scientists, epidemiologists, statisticians or other investigators for pre-competitive data sharing in drug development, public health studies, clinical trials and basic biomedical research. In this configuration, the system may provide data about subpopulations of patients or patient cohorts that are classified as clusters for analysis. In the context of this embodiment, less emphasis is placed on diagnostic decision-making for an individual diagnosed with a disease or disorder, and instead the system is used as a more inclusive, population-based processor for the output of integrated structured and unstructured data for applications such as patient stratification in clinical trials, pattern recognition of non-obvious disease trends in human populations, post-market surveillance, and the analysis of data from specimen biobanks.

The modular nature of the system allows selective application of certain components. For example, medical ontologies created from the semantic web can be used to extract knowledge from the pharmacogenomics literature. Since the published literature on pharmacogenomics is rapidly increasing, methods are needed to keep abreast of the state-of-the-art. This literature is expressed in an unstructured form, and is best addressed through the use of natural language processing (NLP). NLP can be used to identify entities of 33 pharmacogenomic and other variables (such as genes, gene variants, drugs, drug responses and drug-drug interactions) and the relations between these entities in unstructured text. After extraction, entities and relations can be normalized with standard dictionaries and ontologies, and encoded in a structured format. Such normalized relations can subsequently be compared with other literature derived relations and to the content of other databases. Representations of the extracted normalized relations can be made available to a broader community of researchers, drug developers and medical practitioners.

Other features and advantages of the present invention are apparent from the different examples. The provided examples illustrate different components and methodology useful in practicing the present invention. The examples do not limit the claimed invention. Based on the present disclosure the skilled artisan can identify and employ other components and methodology useful for practicing the present invention.

### Example 1

The following hypothetic example shows how the systems and methods of the present invention are used in clinical decision support for a patient (Jane Doe, whom, e.g., has been diagnosed with PTSD).

First, the system computes the best three dimensional isograph for the patient's genomic data by matching that data against one of a set of pre-defined phenotype models in the form of three dimensional isographs. The following steps are included in this process:
1. Extract all clinical text from all electronic health record data and other clinical notes, using the system shown in FIG. 6. All data are converted into the three dimensional vector space of the tri-graph generator.
2. From biobanked samples, or as collected from a bodily fluid such as blood cells, preferably peripheral blood monocytes (PBMCs), determine genomic variants and epigenomic variants that are described in Tables 5 and 6. All data are already in a form that fits the three dimensional vector space of the trigraph generator.
3. Using the pre-defined phenotype models (which are stored in the system KDD), fill in any missing data values using probable inference.

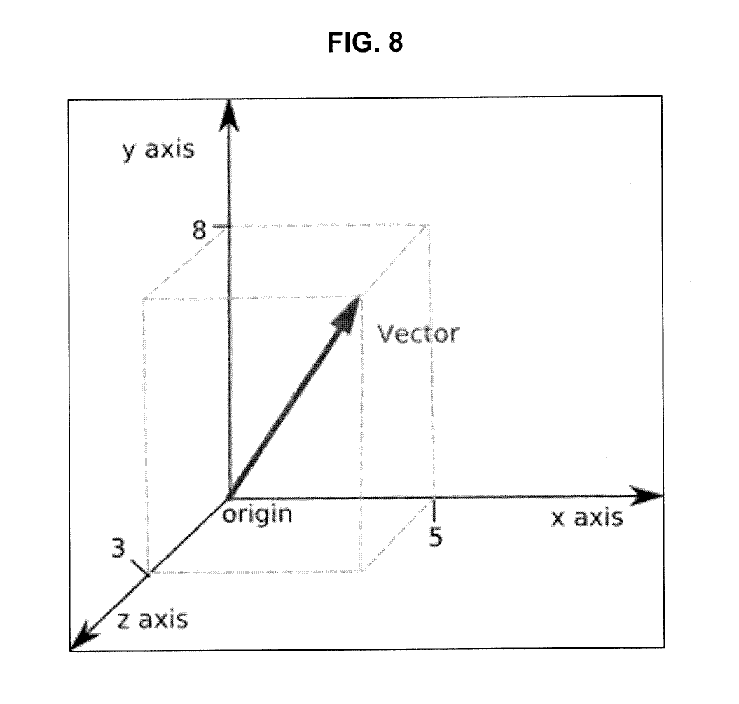

The tri-graph performs the following as described:
1. Compute the distance between each data point and all other data points in the set D.
   So, if Jane Doe has FKBP5 SBP rs1360780 A with 5% methylation, she scores a ‘12.’
2. Find the closest pair of data points from the set D and form a data point set Am (1<=p<=k) which contains these two data points. Delete these two data points from the set D.
   The tri-graph isoform algorithm contained in the tri-graph generator searches for a corresponding value in the stored pre-defined phenotype models for a match (FIG. 8).
3. Find the data point in D that is closest to the data point set Ap. Add it to Ap and delete it from D. Note: since the present methods utilize ‘shaders’, as discussed above, the system is optimized to run on Intel or AMD graphics processors, greatly increasing ‘speed-up.’ If the algorithm cannot find a point match in 3D space, then it always takes the shortest route, without crossing any vectors, to the next available point in the three dimensional vector space
4. Repeat step 3 until the number of data points in Am reaches (n/k)
   This describes the global search of all data points for matching, as well as optimization through repetitive matching.
5. If p<k, then p=p+1. Find another pair of data points from D between which the distance is the shortest. Form another data-point set Ap and delete them from D. Go to step 4
   This says the SVM screwed up, so go back and search and compute again.

Algorithm 1

For each data point set Am (l <= p <= k) find the arithmetic mean of the
vectors of data points Cp(l <= p <= k) in Ap.
Select nearest object of each Cp(l <= p <= k) as initial centroid.
Compute the distance of each data point di (l <= i <= n) to all the
centroids cj (l <= j <= k) as d(di, cj)
For each data point di, find the closest centroid cj and assign di to cluster j
Set ClusterId[i] = j; // j: Id of the closest cluster
Set Nearest_Dist[i] = d(di, cj)
For each cluster j (l <= j <= k), recalculate the centroids

So, Jane Doe has the following values:

| GENE | SNP or variant | Epigenome Variant | OUTPUT |
|---|---|---|---|
| ADCYAP1R1 | rs2267735 | | 1 |
| ADRA2A | rs6311 | | 3 |
| | rs11195419 | | |
| BDNF | | Exon IV; 60% Methylation | 1 |
| | | score | |
| FKBP5 | rs1360780 A | 75% | 1 |
| NR3C1 | Exon 1F | 30% | 3* |

| | |
|---|---|
| TOTAL OMIC VARIANT SCORE→ | 11 |

*The pattern matching can only deal with whole numbers, given the training approach utilized here

Without more, the test subject would match the following stored phenotype: “Poor responders, require sertraline and paroxetine and CBT, FDA-approved sedative-hypnotics for insomnia, low dose anti-psychotics to control symptoms, and other medications to control co-morbid disease for an indefinite period of time, close monitoring for self-harm and harm to others.”

However, natural language processing (NLP) was also used to extract clinical data from the subject's electronic health record and other sources, so these variables must be integrated into the subject's 3D isograph pattern match. This is done using multi-dimensional vector space.

So, the search algorithm first looks for an indexed and prioritized list of clinical values that have been transformed into 3D vector space using a modification of Kiang (Kiang, T. et al. Integrating Advanced Shader Technology for Realistic Architectural Virtual Reality Visualization. Computer-Aided Architectural Design Futures (CAADFutures) 2007 pp. 431-443). According to the methods of the invention the priorities are manually pre-computed—that is one reason this approach is called semi-supervised.’

Indexed list of variables extracted using natural language processor (NLP)—the learning machine transforms all laboratory values, clinician's notes, etc.:

| RANK | CPT codes: | OUTPUT |
|---|---|---|
| 1 | PTSD: 309.81 | Other: 2 |
| | PCL-M | 1 |
| | CAPS | 2 |
| 2 | Anxiety Disorders: 300.00 to 300.09, 300.20 to 300.29, and 300.3. | 5 |
| | Depressive disorders: 296.20 to 296.35, 296.50 to 296.55, 296.90, | 5 |
| | and 300.4. | |
| 3 | Psychoses, 298 to 298, Schizophrenia, 295, Adjustment Disorder, | 6 |
| | 309.0 to 309.9 (excluding 309.81), Affective Disorders, 924, | |
| | Personality Disorders, 301, Sexual Disorders, 302, Depressive | |
| | disorders not elsewhere classified, 311, and other mental | |
| | diagnoses. | |
| 4 | Substance abuse disorders: 304 (drug dependence), 303 (alcohol | 8 |
| | dependence), and 305 (excludes codes for nicotine dependence). | |

PCL-M: The PTSD checklist for military personnel.
CAPS: Clinician Administered PTSD Score - considered not as reliable.
*Other: Refers to any clinical notes that mentions “PTSD” or “PTS” in any form that the training set considers, that, in the context of surrounding words, it is a diagnostic statement made by a clinician about Jane Doe.

The result is a linear sum—but that is not what the algorithms check for—they are assigned a vector in 3D space for the isograph, so that it can perform pattern-matching. So, there are a number of other variables and associations that can only be determined in an efficient manner by a learning machine, including:
1. Sex versus ADCYAP1R1 SNP, or any SNP or MNP that disrupts an estrogen response element (ERE).
2. Ethnicity: Population stratification shows that both ethnicity and economic status ‘pre-dispose’ an individual in such a manner that only an SVM trained on our Knowledge Discovery Database (KCC) can understand.
3. If certain genome variants and epigenome variants do not co-exist in an individual, it is not a meaningful association.
4. Any notes related to child abuse between the ages of 0-5 years of age, especially for females.
5. Any criminal records, including those from the military police or the National Crime Information System database—these are weighted by the system according to associations between the type of crime indicative of an individual with PTSD, and/or any of the other prioritized CPT codes.
6. Any drug information about an individual that would contraindicate prescription of any medication used to treat PTSD.

### EQUIVALENTS

Those skilled in the art will recognize or be able to ascertain using no more than routine experimentation, many equivalents to the specific embodiments of the invention described herein. Such equivalents are intended to be encompassed by the following claims.

All references cited herein are incorporated herein by reference in their entirety and for all purposes to the same extent as if each individual publication or patent or patent application was specifically and individually indicated to be incorporated by reference in its entirety for all purposes.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims.

What is claimed is:

1. A method for selecting a medication for administration to a psychiatric patient in need of treatment for anxious depression or post-traumatic stress disorder (PTSD) by creating a patient-specific phenotype model and classifying the patient into one of a set of pre-defined phenotype models, the phenotype model indicating the diagnostic phenotype of the patient and the medication for administration to the patient, the method comprising the steps of
receiving at a semantic ontology processor a set of patient specific input data in the form of unstructured data including clinical narratives, written prescriptions, or notes written in free text;
processing the unstructured data through a series of steps including
filtering the data to detect and correct errors,
sorting the data through higher order labeling and indexing,
tokenization, and
lexicon verification against a standard collection of medical terms;
converting the data into three dimensional vector space in the form of a three dimensional graph (tri-graph);
extracting from the processed patient data a set of clinical variables associated with anxious depression or PTSD;
applying a pre-trained machine learning algorithm to the set of clinical variables wherein the machine learning algorithm is operative to identify the set of variables and associations that are meaningful for classification;
outputting from the machine learning algorithm the most probable classification of the patient-specific unstructured data as a first pattern classification set in the form of a three dimensional graph (trigraph);
receiving at a second processor a set of patient specific input data in the form of structured data including genetic data;
processing the structured data through a series of steps including extracting, sorting and binning the data;
applying a pattern recognition algorithm to the processed data;
outputting the most probable classification of the patient-specific structured data as a second pattern classification set in the form of a three dimensional graph (trigraph);
receiving at a data fusion module the first and second pattern classification sets and integrating the first and second data sets using a multi-modal approach;
outputting the result as a patient-specific phenotype model;
comparing the patient-specific phenotype model to a set of pre-defined phenotypes stored in the system knowledge discovery dataset (KDD) using three dimensional isograph pattern matching;
outputting the most probable classification of the patient-specific phenotype model; and
selecting a medication based on the output phenotype model.

2. The method of claim 1, wherein missing patient data is compensated for using probable inference from the set of pre-defined phenotype models stored in the system KDD.

3. The method of claim 1, wherein the set of pre-defined phenotype models stored in the system KDD is selected from the set of PTSD phenotype models in Table 1.

4. The method of claim 1, wherein the structured data further includes epigenetic data and clinical data.

5. The method of claim 1, wherein the genetic data includes the patient's polymorphic status at a gene for a single nucleotide polymorphism (SNP) or a multi-nucleotide polymorphism (MNP) and the gene is selected from the group consisting of ADCYAP1R1, ADRA2A, BDNF, CRHBP, CRHR1, FKBP5, HT2RA, NR3C1, NTRK2 and SLC6A4.

6. The method of claim 5, wherein the genetic data further includes the patient's polymorphic status in at least three cytochrome P450 genes selected from CYP2D6, CYP2C19, and CYP1A2.

7. The method of claim 5, wherein the genetic data further includes the patient's polymorphic status in at least three cytochrome P450 genes selected from CYP2D6, CYP2C 19, and CYP1A2 and the serotonin transporter gene, SLC6A4 and the serotonin 2A receptor gene, HTR2A.

8. The method of claim 5, wherein the SNP or MNP is selected from the group consisting of ADCYAP1R1 rs2267735, ADRA2A rs6311, ADRA2A rs11195419, BDNF rs962369, CRHBP rs10473984, CRHR1 rs4792887, CRHR1 rs110402, FKBP5 rs3800373, FKBP5 rs1360780, FKBP5 rs9296158, HT2RA rs9316233, NR3C1 rs852977, NR3C1 rs6195, NR3C1 rs10052957, NR3C1 rs41423247, NTRK2 rs1439050, and SLC6A4XL28 variant selected from the XLA, LA, S, and LG variants.

9. The method of claim 4, wherein the epigenetic data includes the methylation density of a genetic regulatory element selected from the group consisting of the first CpG island of ADCYAP1R1, Exon 1_{F} of NR3C1 promoter, intron 2 or intron 7 of FKBP5, cg22584138 of SLC6A4, and cg05951817 of SLC6A4.

10. The method of claim 4, wherein the clinical data includes at least three or more clinical co-variables selected from the group consisting of Age, Height, weight (Body Surface Area, BSA), Ethnicity, Gender, Number of medications, Drug-Drug Interactions, Drug-Gene Interactions, Number of co-morbid psychiatric diseases, Number of co-morbid non-psychiatric diseases, Structured family history, and one or more psychiatric scales.

11. A system for pharmacogenomic decision support in psychiatry, the system comprising a text mining module, a data mining module, a decision module, and a knowledge discovery dataset (KDD),
the text mining module being operative to receive input unstructured text data, the module comprising
a semantic ontology processor connected to a semantic web interface and operative to extract data from a plurality of web-based medical ontologies and to transform the data into three dimensional vector space in the form of a three dimensional graph (trigraph),
a learning machine operative to apply an unsupervised machine learning process to an ontology training set created by the semantic ontology processor from the input unstructured text data and the data extracted through the semantic web interface into a pattern classification set;
the data mining module being operative to receive structured input data including structured clinical data, genomic data, and epigenomic data, the module comprising
a data filter operative to extract data, correct errors in the data, sort the data, and transform the data into three dimensional vector space in the form of a three dimensional graph (trigraph),
a pattern recognition module, and
a data fusion module comprising a learning machine operative to apply an unsupervised machine learning process to integrate the data from the pattern recognition module into a pattern classification set,
the decision module operative to receive the pattern classification sets from the text mining module and the data mining module and to compare the sets to a set of pre-defined phenotype models and identify the most probable match to a pre-defined phenotype model using pattern matching in three dimensional vector space, and
the knowledge discovery dataset (KDD) having stored within it the pre-defined phenotype models.

12. A method for creating a patient-specific phenotype model in the form of a three dimensional tri-graph in vector space using machine learning algorithms.
